(19) United States
(12) Patent Application Publication
(10) Pub. No.: US 2026/0320805 A1
(43) Pub. Date: Oct. 15, 2026

(54) Apparatus and method for recognizing at least one person in image data and person counting system

(71) Applicant: SICK AG, Waldkirch (DE)

(72) Inventor: Markus HAMMES, Freiburg (DE)

(21) Appl. No.: 19/467,000

(22) Filed: Feb. 2, 2026

(30) Foreign Application Priority Data
Apr. 15, 2025 (EP) 25170758.4

(51) Int. Cl. G06T 7/20; G06V 10/82; G06V 40/10; G06V 40/20

(52) U.S. Cl. CPC G06T 7/20; G06V 10/82; G06V 40/10; G06V 40/25; G06T 2207/20081; G06T 2207/20084; G06T 2207/30196; G06T 2207/30242

(57) ABSTRACT

In one embodiment, an apparatus for recognizing at least one person in image data comprises a first data input, a first preprocessing unit and a main processing unit. The first data input is suitable for supplying a first sequence of individual images. The first preprocessing unit is configured to produce a first movement track image from a first settable number of consecutive individual images of the first sequence in each case. The main processing unit is configured to evaluate the first movement track image and to provide an output signal therefrom. The output signal indicates persons and/or their number recognized at least in the first movement track image during the evaluation.

The present invention relates to an apparatus for recognizing at least one person in image data, to a person counting system and to a method for recognizing at least one person in image data.

Regions that are safe for humans and free of dangerous machines or automatic machines and regions which are not safe for persons, in which dangerous machines or self-propelled, automatically controlled vehicles are present from which humans must in particular be protected, are produced due to the automation of factories. In such an environment, it may be desirable to detect a number of persons who are in a dangerous region.

This function makes it necessary to reliably distinguish between persons and other objects. The classification of objects in images is usually implemented on the basis of individual images with the help of an artificial intelligence-supported, AI-supported, image classification. In dynamic scenarios, image series are also used as input data because an object tracking can be carried out therein at the same time. For example, an AI in the form of a neural network searches for relevant objects in individual images, classifies them and outputs the respective position and an associated bounding box, i.e. a bounding frame that encloses the recognized object or the recognized person. Alternatively, other identifications, such as the segmentation of the pixel regions belonging to an object or a person, are performed. In a classic post-processing step, these output data of consecutive image data sets are correlated. The correlation is achieved in that the detections of individual images are merged in a temporal motion sequence (“track”) and in that consistency checks of the image series take place. Such consistency checks, for example, relate to the stability of the classifications.

However, the known approach of extracting relevant information from individual images and then merely placing the abstracted or summarized object information in a temporal context inevitably leads to a certain loss of information. Relevant distinguishing features of persons and other objects are thereby lost.

A further disadvantage of the known approach is that images, in particular two-dimensional (2D) images, are used that may, however, contain personal data and that cannot be meaningfully anonymized without removing relevant features or introducing false features. The collection, storage and use of these data in the European Economic Area are therefore problematic.

Consequently, an object of the present invention is to provide an apparatus for recognizing at least one person in image data, and an associated method, that achieves an improvement over the prior art. In particular, the recognition should fulfill the requirements of functional safety.

This object is satisfied by the subjects of the independent claims. Further developments and embodiments are the subject of the dependent claims.

In a first embodiment, an apparatus for recognizing at least one person in image data has a first data input, a first preprocessing unit and a main processing unit. The first data input is suitable for supplying a first sequence of individual images. The first preprocessing unit is configured to produce a first movement track image from a first settable number of consecutive individual images of the first sequence in each case. The main processing unit is configured to evaluate the first movement track image and to provide an output signal therefrom. The output signal indicates persons and/or their number recognized at least in the first movement track image during the evaluation.

In the apparatus according to the invention, the first sequence of individual images is prepared in the first preprocessing unit for the evaluation in the downstream main processing unit such that a plurality of consecutive individual images are combined to form the first movement track image. This additional processing step makes it possible that distinguishing features between objects and persons, for example, stand out more clearly so that a reliable distinction between persons and objects is guaranteed in the evaluation.

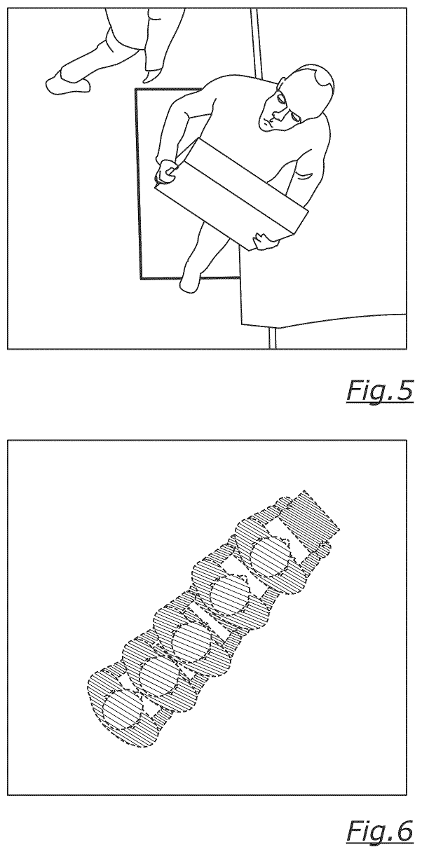

The sequence of individual images is, for example, generated by a suitable digital camera in a known manner. An individual image is, for example, a two-dimensional individual image, in particular a gray scale image or a color image. Alternatively, the individual image can be a three-dimensional individual image that contains distance information on the respective pixel in its third dimension. Accordingly, the camera can be a depth camera, e.g. a LiDAR camera, that, for example, generates the depth information using a time-of-flight measurement. This distance information can be displayed in color-coded form. Such an individual image can be called a depth map. An exemplary individual image, which can be used in one embodiment of the apparatus according to the invention, is shown in FIG. 5. It is gray scale image of a scene.

According to the invention, a movement track image is formed from a time sequence, i.e. from a plurality of individual images recorded one after the other by a camera and supplied to the first data input of the apparatus. Since the information of a plurality of individual images is combined and displayed in a single movement track image for the respective sequence, a movement of an object that occurred within the sequence of individual images used for the movement track image is, for example, made visible in the one movement track image and is thus made recognizable for the automated image analysis in the main processing unit. During the evaluation, it is therefore possible for the main processing unit to reliably distinguish whether the movement track image contains a person or not and, if necessary, to determine the number of persons in the movement track image. If the movement track image only contains objects or moving objects, this number is zero.

With the output signal, for example, a respective position of a recognized person and/or their bounding box is indicated. A value that is indicated with the output signal and that represents the recognized person or persons can also be designed differently, for example as a trajectory determined from the movement track image, as long as it is ensured that is thereby possible to draw a conclusion about a person and, if necessary, a subsequent or downstream count in order to determine the number.

The number of individual images that are combined in the preprocessing unit to form the movement track image can be set depending on the application. With a small number of individual images, movement features may possibly not be as pronounced, on the other hand, the latency, i.e. the time offset between the recording of the first individual image or its supply to the apparatus according to the invention and the presence of the output signal, remains short. In applications in which latency does not play an important role, more individual images can be used to produce the movement track image. Thus, long movement tracks are visible in the movement track image under certain circumstances, whereby features and differences of persons compared to other objects in the movement track image can become even clearer and can be recognized even more easily in the main processing unit.

In one embodiment, the main processing unit comprises an artificial neural network, in particular a classifying neural network.

The neural network is, for example, implemented as a so-called convolutional neural network (CNN). The neural network can also be called an AI system. In an exemplary implementation, a YOLO, You Only Look Once, network can be used or reused that is known to have a plurality of convolutional layers. In this realization, for example, one of the input channels for RGB image data that is typical for a YOLO network is used to supply the movement track image. Furthermore, it is possible to simultaneously supply a depth map generated by the camera (i.e. a depth image) to a second input channel of the YOLO network and/or to supply a gray scale image or black-and-white image to a third input channel, wherein the gray scale image or black-and-white image in particular corresponds to the depth image, but does not contain any depth information and instead comprises intensity values, for example. In this way, the three input channels that are typically used for the three color components (red, green, blue) can be (re)used.

According to a further development, the neural network was trained in a training phase using a plurality of annotated first training movement track images.

In the training phase, the neural network is, for example, trained in advance, i.e. before its actual use during ongoing operation, using synthetic or real training data. According to the invention, movement track images, which are annotated or labeled and which each show persons or objects and are referred to as training movement track images, are used as training data. The neural network is thus trained to perform a classifying person and object recognition as a functional element of the main processing unit. In an exemplary implementation that is based on a YOLO network, a pre-trained YOLO network can be used that is further trained with the training movement track images in the training phase according to the invention. In particular, in a pre-trained YOLO network, the front layers, which are closer to the input neurons, are already well trained for elementary image data.

In the training phase specified here, the rear layers, which are closer to the output neurons, are substantially adapted by the training.

In a second embodiment, the apparatus additionally has a second data input for supplying a second sequence of individual images and a second preprocessing unit. The second preprocessing unit is configured to produce a second movement track image from a second settable number of consecutive individual images of the second sequence in each case. The main processing unit is further configured to evaluate the first and the second movement track image and to provide the output signal therefrom.

Accordingly, in a pre-processing section of the apparatus according to the invention, i.e. in the first and second preprocessing unit, two movement track images are created in parallel in time from the first and the second sequence of individual images. In this respect, the second sequence and the first sequence refer to the same scene, but differ in a certain respect, as will be explained in more detail below. The movement track images produced in this way are both evaluated in the main processing unit. The quality of the classification performed in the main processing unit is thus improved even further. For example, the classification becomes more stable and the robustness of the decisions of the main processing unit is improved.

A first or second sequence of consecutive individual images in this respect only preferably refers to directly consecutive individual images. Alternatively, every second or every third frame or frames can be supplied at an irregular interval from an individual image sequence as a sequence of individual images to the first or second data input.

In an exemplary implementation, the second settable number of consecutive individual images is adapted to the first settable number of consecutive individual images. In addition, a starting point in time of the second sequence of individual images can be adapted to a starting point in time of the first sequence of individual images. For example, the same scene is recorded twice almost simultaneously in different ways, for example with two different image sensors or cameras. The respective image series that are produced in so doing, referred to here as the first and second sequence of individual images, are supplied to the apparatus according to the invention via the first and second data input. Preferably, the first and the second movement track image are thus based on approximately the same number of individual images that were recorded approximately at the same time.

According to a further development, the first sequence of individual images comprises two-dimensional individual images, in particular gray scale images. The second sequence of individual images comprises three-dimensional individual images, in particular depth maps.

In the second embodiment described above, the movement track images accordingly differ in that the first movement track image was produced on the basis of two-dimensional individual images, for example gray scale images, in the first preprocessing unit, while the second movement track image is produced in the second preprocessing unit using three-dimensional individual images, in particular depth maps. Both the first sequence and the second sequence of individual images are in this respect based on the same scene for which the person recognition or person counting is carried out.

In a further development of the second embodiment, the main processing unit comprises an artificial neural network, in particular a classifying neural network.

The classifying neural network can be used for the evaluation of the first and the second movement track image. Similar to the description above, the neural network can be implemented as a CNN, for example. A YOLO network can form the basis for this.

According to a further development of the second embodiment, the neural network was trained in a training phase using a plurality of annotated first training movement track images and a plurality of annotated second training movement track images.

The classifying neural network, which was trained in advance using suitable first and second labeled training movement track images, can be used for the evaluation of the first and the second movement track image. In the subsequent regular operation of the apparatus, this neural network then classifies objects based on features found or identified by the network during the training phase and is thus able to distinguish persons from other objects. The persons thus determined in the movement track images or their number is provided with the output signal.

According to a further development, the first or the second movement track image is a superposition of the individual images from the settable number of consecutive individual images of the first or the second sequence of individual images.

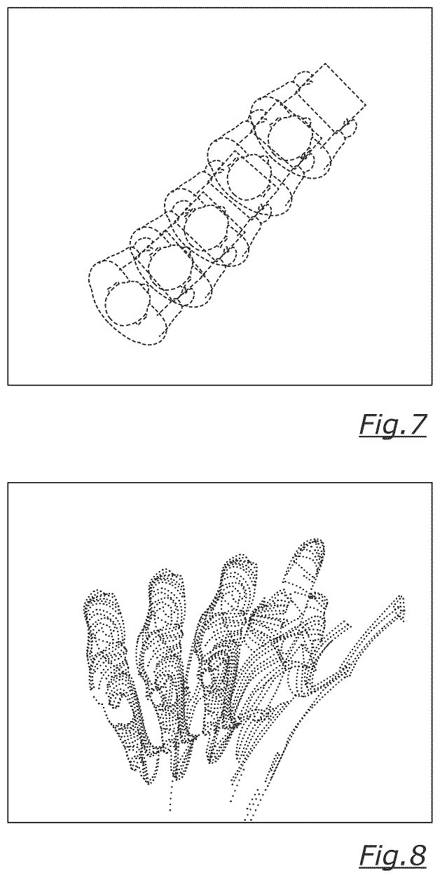

The first movement track image is a superposition or accumulation or aggregation of the individual images from the settable number of consecutive individual images of the first sequence. The second movement track image is a superposition of the individual images from the settable number of consecutive individual images of the second sequence. If two sequences of individual images are used in an exemplary realization, such as the second described embodiment, the first movement track image is, for example, a two-dimensional gray scale image, while the second movement track image is a three-dimensional image or a depth map. An example of a two-dimensional movement track image is shown in FIG. 6, while FIG. 7 shows an exemplary 3D movement track image. In the example, both images have been calculated from five consecutive individual images in each case. The movement track images shown are each based on exemplary sequences of individual images that in this example were recorded at a reduced frame rate of less than 30 frames per second (fps). As a result, the respective movement tracks appear somewhat more fragmented than they would be at a standard frame rate of approximately 30 fps. FIG. 6 and FIG. 7 each show a person in the plan view who, holding an object, has moved from the bottom left to the top right in each case.

In a further development, the first or the second movement track image is formed by a pixel-by-pixel summation and/or a pixel-by-pixel maximum value formation and/or a pixel-by-pixel averaging from the individual images of the settable number of consecutive individual images of the first or the second sequence.

Each movement track image is produced by one or more of the described measures from the individual images of the settable number of consecutive individual images of the respective sequence. For example, image features of different individual images of the image sequence are transferred to a common image, namely the movement track image. Optionally, a background removal can initially take place in each individual image. In this option, a so-called frame differencing, in which consecutive individual images are subtracted, can then be used in order to emphasize moving objects in this way.

By using the movement track images as input data for the main processing unit, temporal relationships that are otherwise only recognizable in a sequence of a plurality individual images can be examined in a single image, namely the movement track image. A movement track image can advantageously also be used to anonymize gray scale images since the finer features of a person that could identify them are thereby so-to-say blurred. However, the relevant movement and shape features of persons are retained in this respect.

A further advantage of using a movement track image is its inherent alienation of personal features that are still visible in the individual images of the respective sequence, as can be seen in FIG. 5. In the movement track image, these optical features are anonymized, as can easily be seen in FIGS. 6 and 7. In this respect, the degree of anonymization inter alia depends on the number of individual images used for the movement track image. Due to this anonymization, the classification and recognition according to the invention of persons in the movement track image also complies with the strict data protection regulations established in Europe regarding the storage and use of data.

According to a third embodiment, the main processing unit is further configured to evaluate at least one individual image from the first sequence of individual images, and to provide the output signal therefrom, in addition to the first movement track image. In this respect, the first sequence of individual images comprises three-dimensional individual images, in particular depth maps.

In this embodiment, in addition to the movement track image, at least one individual image from the sequence on which the movement track image is based is used as input information for the main processing unit. It is thus achieved that the additional optical features and the anonymization in the movement track image are combined with the lower latency of the individual image and the usually easier separability of objects therein. Due to the better anonymization in 3D data, a 2D image or a gray scale image is preferably not used for the additional individual image to be evaluated in this embodiment, but rather a depth map image.

In a further development of the second embodiment, the main processing unit is configured, in addition to the first and the second movement track image, to evaluate at least one individual image from the first or the second sequence of individual images and to provide the output signal therefrom.

In this embodiment, the main processing unit uses the first and the second movement track image and one or more individual images that each originate from the first or the second sequence. In accordance with the above statements, three-dimensional individual images are preferably used in this respect. Thus, specifications regarding anonymization from corresponding data protection regulations are implicitly or automatically implemented. Furthermore, the recognition of persons can be improved even further in this way.

In a further development of the first embodiment, the main processing unit comprises a further artificial neural network, in particular a further classifying neural network, and an output unit. The further neural network was trained in a training phase using a plurality of annotated first training individual images to evaluate at least one individual image from the first sequence of individual images. The output unit is configured to provide the output signal in dependence on an evaluation result of the neural network and an evaluation result of the further neural network. Alternatively, the neural network of the main processing unit was trained during the training phase additionally using a plurality of annotated first training individual images to evaluate at least one individual image from the first sequence of individual images in addition to the first movement track image.

The realization of the main processing unit using artificial intelligence methods can therefore be designed such that exactly one neural network is used to evaluate the first movement track image and one or more individual images. The neural network is accordingly trained in the customary manner with labeled first training movement track images and labeled first training individual images. In an alternative realization, a separate neural network, referred to here as the further neural network, is provided for the parallel evaluation of one or more individual images within the meaning of a concept diversity of the detection. In this form of realization, the main processing unit thus comprises two artificial neural networks. The output unit generates the output signal from the evaluation result, which is provided in the respective output neuron of the respective neural network, by means of a suitable combination, for example, a logical OR operation or logical AND operation. The output unit can optionally additionally consider a quality of the respective evaluation result.

The use of an individual image in the evaluation in addition to a movement track image advantageously achieves a redundancy that is advantageous specifically with regard to the reliability of the person recognition in safety-relevant applications. The approach, in which two separate neural networks are used, enables the aforementioned diversity of concepts in addition to the redundancy. The further neural network is then accordingly trained in advance only with labeled training individual images. Diversity is in this respect achieved both by the different image features in the individual images or movement track images and by the different training processes and possibly different architectures of the neural network used in each case.

In a further development of the second embodiment, the main processing unit comprises a further artificial neural network, in particular a further classifying neural network, and an output unit. The further neural network was trained in a training phase using a plurality of annotated first training individual images and/or a plurality of annotated second training individual images to evaluate at least one individual image from the first sequence of individual images and/or at least one individual image from the second sequence of individual images. The output unit is configured to provide the output signal in dependence on an evaluation result of the neural network and an evaluation result of the further neural network. Alternatively, the neural network of the main processing unit was trained in a training phase additionally using a plurality of annotated first training individual images and/or a plurality of annotated second training individual images to evaluate one or more individual images from the first sequence of individual images and/or one or more individual images from the second sequence of movement track images in addition to the first and the second movement track image.

The evaluation of two movement track images, which are available as a gray scale image and a depth map image, can also be supplemented by the evaluation of one or more individual images, wherein the possibility technically exists of using gray scale images or depth map images for this purpose. To comply with the data protection guidelines given in Europe, depth map images are preferably used as individual images. In the implementation, on the one hand, there is the possibility of training a single neural network in advance using labeled first training movement track images, labeled second training movement track images and labeled first and/or second training individual images. In a second implementation possibility, again within the meaning of concept diversity, two different neural networks are provided, wherein the one is trained with the first and the second labeled movement track image, and the other is trained for a person recognition with labeled individual images, preferably depth map images.

In a further development, the first and/or second annotated training movement track images used in the respective training phase have different classes of objects and are annotated in accordance with these classes.

An assignment to an accurate or correct output class is made by the annotating or the labeling.

In particular, the different classes comprise at least a human class, a vehicle class and a humanoid robot class.

In this respect, the vehicle class can, for example, comprise autonomous vehicles such as Automated Guided Vehicles (AGVs) or machines.

In particular, the respective training phase takes place in accordance with a supervised learning.

Preferably, the training data, i.e. the training movement track images and/or the training individual images, are designed for the respective application to be realized.

In a further development, a training movement track image of the human class comprises at least one movement feature that is characteristic of a person, for example a temporal pendulum movement and/or rocking movement of a person in locomotion, a movement of at least one extremity of a person in locomotion, a plastic deformation of the body of a person in locomotion.

A movement feature is, for example, a geometric movement pattern. As is known, a movement performed by a person, in particular locomotion, differs from a movement of a humanoid robot by a greater irregularity, for example. Due to the use of a large number of different training movement track images, the variance of the respective movement patterns included therein within a class, but also across different classes, is increased and thus the recognition of persons is improved even further.

Due to the training phase according to the invention and using the described training data, the main processing unit, in particular the neural network or networks used here in each case, is trained to recognize persons contained in the movement track images. In addition, a direction of movement can also be evaluated that, for example, records a course of the movement or trajectory. This is particularly advantageous when the apparatus according to the invention is used to count persons who switch between two different spatial regions.

In one embodiment, a person counting system comprises the apparatus according to the invention for recognizing at least one person in image data according to any one of the embodiments described above, and a camera for producing the individual images. A data output of the camera is connected to the data input of the apparatus. The person counting system is configured to functionally safely detect a number of passages of persons across a boundary in dependence on the output signal of the apparatus.

For example, the person counting system is used in a passage counter to record the number of persons who have passed through the passage, in particular in the respective direction. Thus, such a passage counter can be used at the transition between a safe region and a hazardous region in a factory to determine a number of persons in the hazardous region in a functionally safe manner. In accordance with applicable safety standards, such as IEC61508 or ISO13849, the passage counter must be designed safely so that the meter reading determined by it can be used in a safety-relevant manner for the risk minimization.

Functional safety refers to that part of the safety of a system which depends on the correct function of the safety-related system and on other risk-reducing measures. The challenges of known counting systems lie in the distinction between persons and other objects, for example the pieces of luggage taken along by persons, e.g. a flipchart, and the separation of persons into person groups. Known systems are optimized here with respect to a specific distinguishing capability between persons and other objects, but are not enhanced with respect to a particular reliability within the meaning of functional safety. In contrast, the person counting system according to the invention is enhanced with respect to the functional safety and enables a reliable recognition of persons in particular due to the use of the movement track images.

A further embodiment of the invention relates to a computer-implemented method for recognizing at least one person in image data. The method comprises the following steps:
supplying a first sequence of individual images,
producing a first movement track image from a settable number of consecutive individual images of the first sequence,
evaluating the first movement track image, and
providing an output signal that indicates persons and/or their number recognized at least in the first movement track image during the evaluation.

In the method, the additional step of producing movement track images and the subsequent evaluation thereof is used to improve the recognition of persons in image data, whereby the recognized persons or their number provided with the output signal meets the requirements for functional safety.

In one embodiment, the computer-implemented method is used in the apparatus according to the invention described above.

In another respect, the above statements on the apparatus according to the invention apply accordingly to the method; in particular with respect to advantages and embodiments. The embodiments mentioned can all be combined with one another, unless explicitly stated otherwise.

The invention will be explained by way of example in more detail with reference to the Figures. Components with the same function or effect have the same reference symbols. There are shown:

FIG. 1 a first embodiment example of the apparatus as proposed;

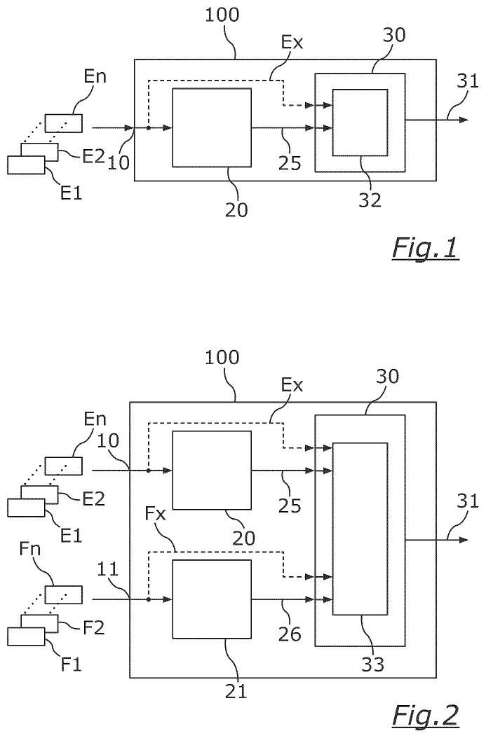

FIG. 2 a second embodiment example of the apparatus as proposed;

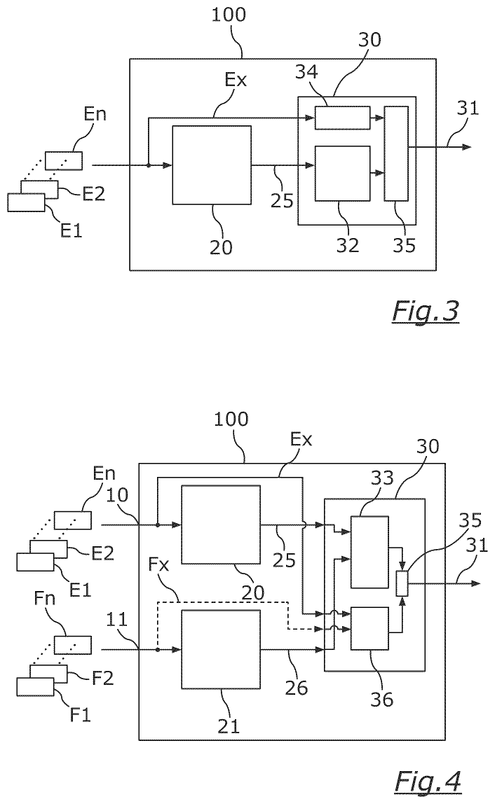

FIG. 3 a third embodiment example of the apparatus as proposed; and

FIG. 4 a fourth embodiment example of the apparatus as proposed;

FIG. 5 an exemplary individual image;

FIG. 6 an exemplary movement track image;

FIG. 7 a further exemplary movement track image; and

FIG. 8 a Further Exemplary Movement Track Image.

FIG. 1 shows a first embodiment example of an apparatus as proposed. The apparatus 100 for recognizing at least one person in image data has an input 10 for supplying a first sequence of individual images E1, E2, . . . , En. These individual images E1 to En were, for example, produced by a camera, not shown here, in particular a 2D or 3D camera. The preprocessing unit 20 produces a movement track image 25 from a predetermined number of individual images. This movement track image 25 corresponds, so to speak, to a superposition of these plurality of successively recorded individual images. The main processing unit 30 evaluates the movement track image 25 and thereby determines whether the movement track image 25 shows a person or how many persons are depicted in the movement track image 25. The output signal 31 is provided accordingly and indicates the persons, or their number, recognized in the movement track image 25.

The superposition of a plurality individual images leads to distinguishing features of persons and other objects, such as a characteristic pendulum movement of a person when walking, being more strongly emphasized and thus a classification in the main processing unit 30 taking place with a higher quality. Furthermore, this superposition leads to a certain anonymization of persons, who may be even more clearly recognizable in the individual images. Thus, the processing of the supplied image data takes place in compliance with the specified data protection guidelines.

A neural network 32 is, for example, used in the main processing unit 30. It is trained in advance with synthetic or real movement track images 25 so that an evaluation leads to the correct result. During the training phase, the neural network is provided, as described, with examples of different classes by supplying the annotated training movement track images. In this phase, the neural network independently develops features which are only recognizable within the structure of the neural network and based on which the classification takes place during ongoing operation.

Optionally, an individual image Ex is additionally used for the evaluation in the main processing unit 30. This individual image Ex is in this respect one of the individual images on which the movement track image 25 just generated in the preprocessing unit 20 is based. In this embodiment, the output signal 31 is generated due to the evaluation of the individual image Ex and the movement track image 25. If the main processing unit 30 is implemented using a single neural network, the neural network 32 is in this case trained in advance with labeled training movement track images 25 and labeled training individual images Ex.

FIG. 2 shows a further embodiment example of the apparatus 100 as proposed. This example corresponds to the example of FIG. 1 and additionally has a second input 11 via which a second sequence of individual images F1, F2, . . . , Fn is supplied to the apparatus 100. This second sequence of individual images, or a number of these individual images, is used in the second preprocessing unit 21 to produce a second movement track image 26 therefrom. The second movement track image 26 is supplied in parallel with the first movement track image 25 to the main processing unit 30. It evaluates both movement track images 25 and 26 and thus provides the output signal 31 that contains information on whether or how many persons were detected in the movement track images 25 and 26.

The first sequence of individual images E1 to En contains, for example, 2D images or gray scale images, while the second sequence of individual images F1 to Fn contains 3D images or depth maps.

If the main processing unit 30 is realized with the aid of a neural network 33, the neural network 33 is trained in advance with labeled first training movement track images 25 and labeled second training movement track images 26.

In an exemplary implementation, the neural network 33 is realized on the basis of a YOLO network. Of the three quasi-identical input channels, one channel is used for the first movement track image 25, a second channel for the second movement track image 26, and the third channel for the second sequence of depth map individual images F1 to Fn. For example, the network 33 provides positions, marked by so-called bounding boxes, where a person has been identified. For example, a track is determined for the movement track image.

In this respect, it only depends on the architecture of the neural network whether the 2D and 3D movement track images are evaluated in parallel or separately. In a separate evaluation, two independent classification results are determined for the two image channels. The final decision, which is output with the result signal, can then be made in different ways: In cases where it is particularly important not to overlook a person, the logic “if at least one of the two decisions had a person as a result, the overall result is also a person” would e.g. be used within the meaning of a logical OR link of the decisions.

Optionally, the main processing unit 30 can include one or more individual images Ex from the first sequence of individual images, and alternatively or additionally one or more individual images Fx from the second sequence of individual images, in its respective evaluation. In this case, the single neural network 33 is trained in advance with labeled first training movement track images 25, labeled second training movement track images 26, labeled training individual images Ex of the first sequence and/or labeled training individual images Fx of the second sequence.

FIG. 3 shows a third embodiment example of the apparatus 100. This embodiment example corresponds to the embodiment example of FIG. 1, with the difference that two separate neural networks 32 and 34, as well as an output unit 35, are provided for the evaluation in the main processing unit 30. As in FIG. 1, the neural network 32 processes the first movement track image 25 and generates a first evaluation result for the output unit 35 therefrom. The additionally evaluated individual images Ex are processed in a separate neural network 34. It generates a second evaluation result that is likewise supplied to the output unit 35. The output unit 35 generates the output signal 31 from both evaluation results. Both neural networks 34 and 32 are accordingly trained in advance. That is, the neural network 32 is trained with labeled first training movement track images 25, while the neural network 34 is trained in advance with labeled training individual images Ex.

This realization advantageously offers a high diversity both through the different image features and through the different training processes that may lead to different architectures of the two neural networks 32 and 34. A quality of the classification is thereby improved even further.

FIG. 4 shows a fourth embodiment example of the apparatus 100 as proposed. This example corresponds to the embodiment example of FIG. 2, except for the realization of the main processing unit 30. In FIG. 4, two separate neural networks 33 and 36 are used in the main processing unit 30. The first and the second movement track image 25 and 26 are evaluated in the neural network 33. Individual images Ex of the first sequence and/or individual images Fx of the second sequence are processed in the neural network 36. A respective evaluation result of the neural network 33 and the neural network 36 is supplied to the output unit 35 that determines the output signal 31 therefrom. In this embodiment example, the reliability of the classification is also increased even further by the concept diversity.

FIG. 5 shows an exemplary individual image that can be a part of the first or the second sequence of individual images. An image of a gray scale channel of a camera is shown. It can be seen that the identity of the depicted person can by all means be determined based on the image.

FIG. 6 shows an example of a movement track image that was calculated from 2D gray scale individual images.

FIG. 7 Shows a Further Exemplary Movement Track Image That Was Accumulated from 3D individual images.

FIG. 8 shows a further example of a movement track image as a 3D point cloud. It can be seen that the specific shape of a person leaves behind characteristic features in the movement track shown. Said movement track differs significantly from the track of a vehicle or a rigid object.

By adding a corresponding label, each of the images of FIGS. 6 to 8 can be used as a training movement track image. By appropriately annotating the individual image from FIG. 5, an exemplary training individual image is produced.

### REFERENCE NUMERAL LIST

E1, E2, . . . , En individual image
F1, F2, . . . , Fn individual image
10, 11 input
20, 21 preprocessing unit
25, 26 movement track image
30 main processing unit
31 output signal
32, 33, 34, 36 neural network
35 output unit

1. An apparatus for recognizing at least one person in image data, comprising a first data input for supplying a first sequence of individual images,
a first preprocessing unit that is configured to produce a first movement track image from a first settable number of consecutive individual images of the first sequence in each case,
a main processing unit that is configured to evaluate the first movement track image and to provide an output signal therefrom, said output signal indicating persons and/or their number recognized at least in the first movement track image during the evaluation.

2. The apparatus according to claim 1,
wherein the main processing unit comprises an artificial neural network.

3. The apparatus according to claim 2,
wherein the neural network was trained in a training phase using a plurality of annotated first training movement track images.

4. The apparatus according to claim 1,
further comprising
a second data input for supplying a second sequence of individual images, a second preprocessing unit that is configured to produce a second movement track image from a second settable number of consecutive individual images of the second sequence in each case, and
wherein the main processing unit is further configured to evaluate the first and the second movement track image and to provide the output signal therefrom.

5. The apparatus according to claim 4,
wherein the first sequence of individual images comprises two-dimensional individual images, and
wherein the second sequence of individual images comprises three-dimensional individual images.

6. The apparatus according to claim 4,
wherein the main processing unit comprises an artificial neural network.

7. The apparatus according to claim 6,
wherein the neural network was trained in a training phase using a plurality of annotated first training movement track images and a plurality of annotated second training movement track images.

8. The apparatus according to claim 1,
wherein the first or the second movement track image is a superposition of the individual images from the settable number of consecutive individual images of the first or the second sequence of individual images.

9. The apparatus according to claim 1,
wherein the main processing unit is further configured, in addition to the first movement track image, to evaluate at least one individual image from the first sequence of individual images and to provide the output signal therefrom,
wherein the first sequence of individual images comprises three-dimensional individual images.

10. The apparatus according to claim 3,
wherein the main processing unit comprises a further artificial neural network, and an output unit, wherein the further neural network was trained in a training phase using a plurality of annotated first training individual images to evaluate at least one individual image from the first sequence of individual images, and wherein the output unit is configured to provide the output signal in dependence on an evaluation result of the neural network
and an evaluation result of the further neural network, or
wherein the neural network of the main processing unit was trained during the training phase additionally using a plurality of annotated first training individual images to evaluate at least one individual image from the first sequence of individual images.

11. The apparatus according to claim 7,
wherein the main processing unit comprises a further artificial neural network, and an output unit, wherein the further neural network was trained in a training phase using a plurality of annotated first training individual images and/or a plurality of annotated second training individual images to evaluate at least one individual image from the first sequence of individual images and/or at least one individual image from the second sequence of individual images, and wherein the output unit is configured to provide the output signal in dependence on an evaluation result of the neural network and an evaluation result of the further neural network, or
wherein the neural network of the main processing unit was trained during the training phase additionally using a plurality of annotated first training individual images and/or a plurality of annotated second training individual images to evaluate at least one individual image from the first sequence of individual images and/or at least one individual image from the second sequence of individual images.

12. The apparatus according to claim 3,
wherein the first and/or second training movement track images used in the respective training phase have different classes of objects and are annotated in accordance with these classes,
wherein the different classes comprise at least a human class, a vehicle class and a humanoid robot class,
wherein the respective training phase takes place in accordance with a supervised learning.

13. The apparatus according to claim 12,
wherein a training movement track image of the human class comprises at least one movement feature that is characteristic of a person.

14. A person counting system comprising
an apparatus for recognizing at least one person in image data apparatus for recognizing at least one person in image data, the apparatus comprising a first data input for supplying a first sequence of individual images,
a first preprocessing unit that is configured to produce a first movement track image from a first settable number of consecutive individual images of the first sequence in each case,
a main processing unit that is configured to evaluate the first movement track image and to provide an output signal therefrom, said output signal indicating persons and/or their number recognized at least in the first movement track image during the evaluation, and the person counting system further comprising
a camera for producing the individual images, wherein a data output of the camera is connected to the data input of the apparatus,
wherein the person counting system is configured to functionally safely detect a number of passages of persons across a boundary in dependence on the output signal of the apparatus.

15. A computer-implemented method for recognizing at least one person in image data, comprising
supplying a first sequence of individual images,
producing a first movement track image from a first settable number of consecutive individual images of the first sequence,
evaluating the first movement track image, and
providing an output signal that indicates persons and/or their number recognized at least in the first movement track image during the evaluation.

16. The apparatus according to claim 2,
wherein the artificial neural network is a classifying neural network.

17. The apparatus according to claim 4,
wherein the second settable number of consecutive individual images is adapted to the first settable number of consecutive individual images and a starting point in time of the second sequence of individual images is adapted to a starting point in time of the first sequence of individual images.

18. The apparatus according to claim 5,
wherein the two-dimensional individual images are gray scale images.

19. The apparatus according to claim 5,
wherein the three-dimensional individual images are depth maps.

20. The apparatus according to claim 6,
wherein the artificial neural network is a classifying neural network.

21. The apparatus according to claim 9,
wherein the three-dimensional individual images are depth maps.

22. The apparatus according to claim 10,
wherein the further artificial neural network is a further classifying neural network.

23. The apparatus according to claim 11,
wherein the further artificial neural network is a further classifying neural network.

24. The apparatus according to claim 13,
wherein the characteristic of a person is at least one of a temporal pendulum movement of a person in locomotion, a rocking movement of a person in locomotion, a movement of at least one extremity of a person in locomotion, and a plastic deformation of the body of a person in locomotion.
